(19) United States
(12) Patent Application Publication
(10) Pub. No.: US 2025/0198374 A1
(43) Pub. Date: Jun. 19, 2025

(54) FUEL INJECTOR OF AN INTERNAL COMBUSTION ENGINE AND INTERNAL COMBUSTION ENGINE

(71) Applicant: MAN Energy Solutions SE, Augsburg (DE)

(72) Inventors: Christian KUNKEL, Augsburg (DE); Thomas KLAUA, Augsburg (DE)

(21) Appl. No.: 18/981,852

(22) Filed: Dec. 16, 2024

(30) Foreign Application Priority Data
Dec. 19, 2023 (DE) 10 2023 135 688.7
Nov. 5, 2024 (DE) 10 2024 132 162.8

(51) Int. Cl. F02M 43/04; F02M 61/18

(52) U.S. Cl. CPC F02M 43/04; F02M 61/1806

(57) ABSTRACT

A fuel injector for supplying fuel having a first nozzle needle that interacts with first fuel injection orifices to open or block a fuel flow of a first, relatively less ignitable fuel through the first fuel injection orifices, and a second nozzle needle that interacts with second fuel injection orifices and with third fuel injection orifices (to open or block a fuel flow of a second, relatively ignitable fuel both through the second and third fuel injection orifices The first fuel injection orifices inject the first fuel in a first spray cone with a first cone angle. The second fuel injection orifices inject the second fuel in a second spray cone with a second cone angle. The third fuel injection orifices are equipped for injecting the second fuel in a third spray cone with a third cone angle into the combustion space.

### BACKGROUND OF THE INVENTION

### 1. Field of the Invention

The disclosure relates to a fuel injector of an internal combustion engine. Further, the disclosure relates to an internal combustion engine having at least one fuel injector.

The disclosure relates in particular to the field of so-called large engines or large internal combustion engines, the cylinders of which have piston diameters of at least 140 mm, in particular of at least 175 mm. Such large internal combustion engines are for example ships' engines.

### 2. Description of Related Art

Dual-fuel internal combustion engines are already known as ships' engines. Dual-fuel internal combustion engines known from practice can be operated in a first operating mode, in which the same combust a first fuel, in particular a less ignitable fuel, and in a second operating mode, in which the same combust a second fuel, in particular a relatively ignitable fuel.

The first relatively less ignitable fuel can be for example methanol, ethanol or ammonia. The second relatively ignitable fuel can be for example a diesel fuel. In the first operating mode, the first relatively less ignitable fuel, in particular the methanol, ethanol or ammonia, can be ignited via the second relatively ignitable fuel, in particular the diesel fuel.

DE 10 2013 000 048 B3 discloses a fuel injector with the help of which in the first operating mode of a dual-fuel internal combustion engine both the first, relatively less ignitable fuel and also the second, relatively ignitable fuel can be introduced into the combustion chamber of a cylinder. The fuel injector disclosed there has two nozzle needles which are moveably guided in corresponding needle guides. First fuel injection orifices interacting with a first nozzle needle and second fuel injection orifices interacting with a second nozzle needle are each arranged along a circular contour. There are significant restrictions when injecting the fuels into the combustion chamber of a cylinder, so that the combustion space of the combustion chamber cannot be optimally utilised.

### SUMMARY OF THE INVENTION

Starting out from this, one aspect of the present invention is based on the object of creating a new type of fuel injector and an internal combustion engine having such a fuel injector.

The fuel injector comprises a first nozzle needle that is moveably guided in a first needle guide, which interacts with first fuel injection orifices in such a manner that the first nozzle needle, depending on its position, either opens or blocks a fuel flow of the first, relatively less ignitable fuel through the first fuel injection orifices. Further, the fuel injector comprises a second nozzle needle that is moveably guided in a second needle guide, which interacts with second fuel injection orifices and with third fuel injection orifices in such a manner that the second nozzle needle, depending on its position, either opens blocks a fuel flow of a second, relatively ignitable fuel both through the second fuel injection orifices and also through the third fuel injection orifices or opens the same through the second fuel injection orifices and blocks the same through the third fuel injection orifices, or opens the same both through the second fuel injection orifices and also through the third fuel injection orifices.

The first fuel injection orifices are equipped for injecting the first fuel in a first spray cone with a first cone angle into the combustion space. The second fuel injection orifices are equipped for injecting the second fuel in a second spray cone with a second cone angle into the combustion space. The third fuel injection orifices are equipped for injecting the second fuel in a third spray cone with a third cone angle into the combustion space.

With the fuel injector according to the invention, both the first, relatively less ignitable fuel and also the second, relatively ignitable fuel can be optimally introduced into the combustion space of a cylinder. When for example in a first operating mode the first, relatively less ignitable fuel subject to being ignited with the help of the second, relatively ignitable fuel, is to be combusted, the first, relatively less ignitable fuel can be injected via the first fuel injection orifices and for igniting the same, the second, relatively ignitable fuel can be injected into the combustion chamber of the cylinder via the second fuel injection orifices. In this first operating mode, the third fuel injection orifices are preferentially closed permanently. In the second operating mode, in which exclusively the second, relatively ignitable fuel is to be combusted, the first fuel injection orifices are permanently closed, the second fuel is then introduced into the combustion space of the respective cylinder via the second fuel injection orifices and the third fuel injection orifices. Thus, the combustion space of a combustion chamber can be optimally utilised in both operating modes.

Preferentially, the second cone angle is smaller than the third cone angle. In particular when the second cone angle is smaller than the third cone angle, the second, relatively ignitable fuel utilised in the first operating mode for igniting the first, relatively less ignitable fuel, can be particularly advantageously injected into the combustion space of a cylinder.

The first cone angle is preferentially smaller than the second cone angle. Alternatively, the first cone angle is greater than the second cone angle and smaller than the third cone angle or alternatively also greater than the third cone angle.

Preferentially, the first fuel injection orifices are arranged along a pitch circle contour, the second fuel injection orifices along a first circular contour and the third fuel injection orifices along a second circular contour, wherein the first circular contour and the second circular contour are arranged concentrically to one another, wherein a distance between the centre point of the pitch circle contour and the centre point of the first and second circular contour is greater than the sum of the radius of the pitch circle contour and of the radius of the first circular contour and greater than the sum of the radius of the pitch circle contour and of the radius of the second circular contour. This arrangement of the first, second and third fuel injection orifices is particularly preferred for an optimal utilisation of the combustion space of a combustion chamber of a cylinder.

Preferentially, the second and/or fuel injection orifices, in the installed state of the fuel injector, project deeper or further into a combustion chamber of the cylinder than the first fuel injection orifices. Thus, the second fuel, in particular in the second operating mode, in which exclusively the second relatively ignitable fuel is to be combusted, can be particularly advantageously introduced into the combustion chamber of the respective cylinder.

Preferentially, the second fuel injection orifices and the third fuel injection orifices, seen in the circumferential direction, are at least partly offset relative to one another. This also serves for optimally introducing fuel into the combustion chamber of a cylinder, in particular in the second operating mode, in which exclusively the second, relatively ignitable fuel is introduced into the combustion chamber of the respective cylinder, namely via the second and third fuel injection orifices.

### BRIEF DESCRIPTION OF THE DRAWINGS

Preferred further developments of the invention are obtained from the subclaims and the following description. Exemplary embodiments of the invention are explained in more detail by way of the drawing without being restricted to this.

There it shows:

FIG. 1: is a schematic lateral view of a fuel injector;

FIG. 2: is a first schematic cross-section by way of an extract through the fuel injector according to FIG. 1;

FIG. 3 is a second schematic cross-section by way of an extract through the fuel injector according to FIG. 1; and

FIG. 4 is an alternative to FIG. 3.

### DETAILED OF THE PRESENTLY PREFERRED EMBODIMENTS

The disclosure relates to a fuel injector of an internal combustion engine. Such a fuel injector is designed for supplying fuel to a combustion chamber of a cylinder of the internal combustion engine. The fuel injector according to one aspect of the invention serves for supplying different fuels to an internal combustion engine designed in particular as dual-fuel internal combustion engine, for example in a first operating mode for introducing a first, relatively less ignitable fuel, and a second relatively ignitable fuel, in order to ignite via the second, relatively ignitable fuel the first relatively less ignitable fuel in the first operating mode. Further, in a second operating mode, in which exclusively the second, relatively ignitable fuel is combusted, the same is to be injected via the fuel injector into the combustion chamber of the cylinder. The first, relatively less ignitable fuel can be methanol, ethanol or ammonia. The second, relatively ignitable fuel is in particular a diesel fuel.

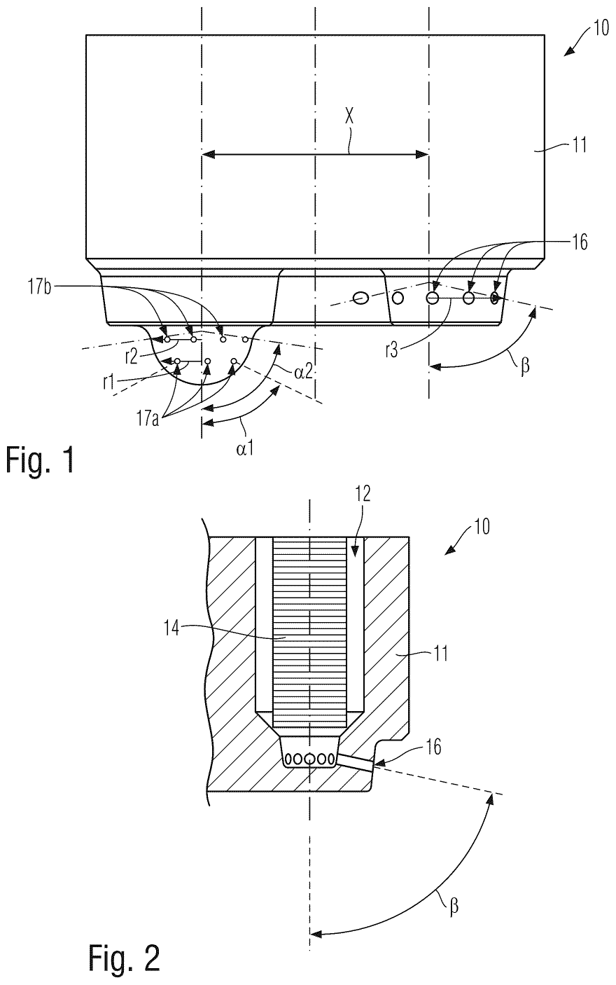

FIGS. 1 to 3 show different views of a fuel injector 10 according to the invention. The fuel injector 10 has a main body 11, which provides two needle guides 12, 13. In a first needle guide 12, a first nozzle needle 14 and in a second needle guide 13 a second nozzle needle 15 is moveably guided.

First fuel injection orifices 16 interact with the first nozzle needle 14 in such a manner that the first nozzle needle 14, depending on its position in the first needle guide 12, either opens or blocks a fuel flow of a first, relatively less ignitable fuel through the first fuel injection orifices 16.

Second fuel injection orifices 17a and third fuel injection orifices 17b interact with the second nozzle needle 15.

In a first relative position of the second nozzle needle 15, the same blocks in the second needle guide 13, the fuel flow of the second, relatively ignitable fuel both through the second fuel injection orifices 17a and also through the third fuel injection orifices 17b.

In a second relative position of the second nozzle needle 15 in the second needle guide 13, the same opens the fuel flow of the second, relatively ignitable fuel through the second fuel injection orifices 17a, but blocks the fuel flow through the third fuel injection orifices 17b.

In a third relative position of the second nozzle needle 15 in the second needle guide 13, the same opens the fuel flow of the second, relatively ignitable fuel both through the second fuel injection orifices 17a and also through the third fuel injection orifices 17b.

The first fuel injection orifices 16, which serve for introducing the first, relatively less ignitable fuel into the combustion chamber of a cylinder, are equipped for injecting the first fuel in a first spray cone with a first cone angle β into the combustion space of a respective cylinder. The second fuel injection orifices 17a are equipped for injecting the second, relatively ignitable fuel in a second spray cone with a second cone angle α1 into the combustion space of the respective cylinder. The third fuel injection orifices 17b are equipped for injecting the second, relatively ignitable fuel in a third spray cone with a third cone angle α2 into the combustion space of the respective cylinder. These cone angles α1, α2 and β according to FIGS. 1 to 4 are angles which are each included by a lateral surface of the respective spray cone with a longitudinal centre axis of the respective spray cone.

It is thus in accordance with the invention for introducing the second, relatively ignitable fuel to utilise the second nozzle needle 15, which interacts both with the second fuel injection orifices 17a and also with the third fuel injection orifices 17b. When an internal combustion engine having such a fuel injector is operated in the first operating mode, in which a first relatively less ignitable fuel is to be combusted and ignited via the second, relatively ignitable fuel, the first, relatively less ignitable fuel is introduced into the combustion space of the respective cylinder via the first fuel injection orifices 16, the second, relative ignitable fuel preferentially exclusively via the second fuel injection orifices 17a. Then, the third fuel injection orifices 17b are not utilised in the first operating mode. When, by contrast, such an internal combustion engine is to be operated in a second operating mode, in which exclusively the second, relatively ignitable fuel is to be combusted, the first fuel injection orifices 16 are permanently closed and the second, relatively ignitable fuel is introduced into the combustion chamber of the respective cylinder both via the second fuel injection orifices 17a and also the third fuel injection orifices 17b.

The second cone angle α1 is preferentially smaller than the third cone angle α2. The second cone angle α1, with which the second fuel injection orifices 17a inject the second, relatively ignitable fuel into the combustion chamber of a respective cylinder, is thus smaller than the third cone angle α2 of the third spray cone, via which the third fuel injection orifices 17b inject the second, relatively ignitable fuel into the combustion chamber of the respective cylinder. The third cone angle α2 amounts to between 66° and 88°, preferentially between 68° and 86°. The second cone angle α1 is smaller than the third cone angle α2. Preferentially, the second cone angle α1 is smaller than 68°, preferably smaller than 66°.

The first cone angle β is preferentially smaller than the second cone angle α1. Alternatively, the first cone angle β is greater than the second cone angle α1 and smaller than the third cone angle α2. Alternatively, the first cone angle β is greater than the third cone angle α2.

The first fuel injection orifices 16, which serve for injecting the first, relatively less ignitable fuel, are preferentially arranged along a pitch circle contour. This pitch circle contour, on which the first fuel injection orifices 16 are arranged, extends over an angular range of 360°-δ, wherein δ defines a residual pitch circle contour on which no first fuel injection orifices 16 are arranged.

The second fuel injection orifices 17a and the third fuel injection orifices 17b are both arranged along a circular contour, namely the second fuel injection orifices 17a along a first circular contour and the third fuel injection orifices 17b along a second circular contour, wherein the first circular contour and the second circular contour are arranged concentrically to one another.

A distance x between the centre point of the pitch circle contour, on which the first fuel injection orifices 16 are arranged, and the centre point of the first and second circular contour, on which the second fuel injection orifices 17a and third fuel injection orifices 17b respectively are arranged, is greater than the sum of the radius r3 of the pitch circle contour and of the radius r1 of the first circular contour and further greater than the sum of the radius r3 of the pitch circle contour and of the radius r2 of the second pitch circle contour.

Neither the first circular contour nor the second circular contour, which are arranged concentrically to one another, thus bisect the pitch circle contour, on which the first fuel injection orifices 16 are positioned.

The residual pitch circle contour defined by the angle δ, on which no first fuel injection orifices 16 are arranged, faces the first circular contour and the second circular contour.

The second fuel injection orifices 17a are those fuel injection orifices for the second, relatively ignitable fuel, which in the second operating mode, in which exclusively the second, relatively ignitable fuel is combusted, open before the third fuel injection orifices 17b. Preferentially, the second fuel injection orifices 17a have a smaller cross-sectional opening than the third fuel injection orifices 17b.

In the installed state of the fuel injector, the second and/or third fuel injection orifices 17a, 17b are arranged deeper or further in a combustion chamber of the cylinder or project deeper or further into the combustion chamber of the respective cylinder than the first fuel injection orifices 16. Preferentially, both the second and also the third fuel injection orifices 17a and 17b project deeper or further into the combustion chamber than the first fuel injection orifices 16.

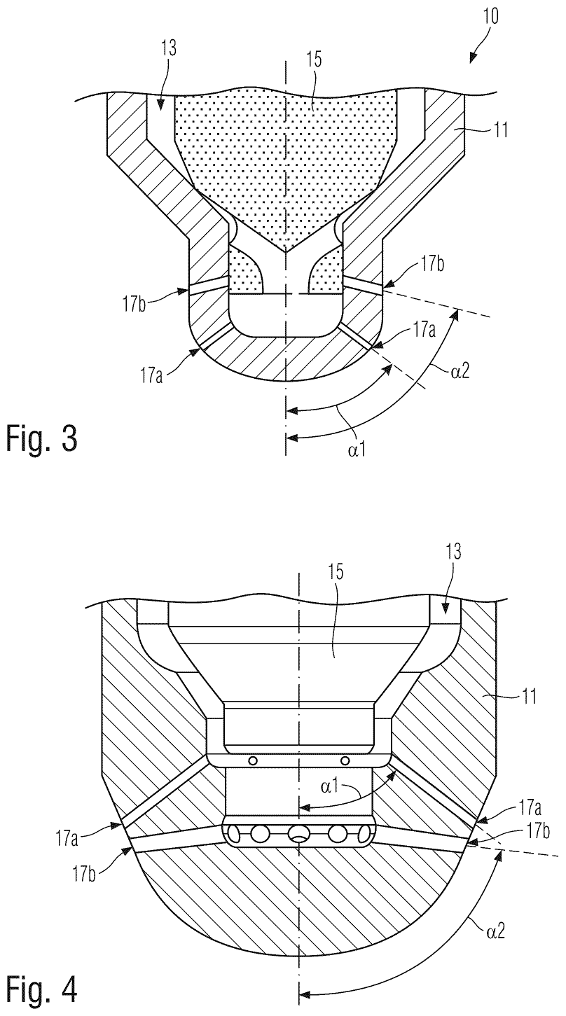

FIGS. 3 and 4 differ by the relative position of the second fuel injection orifices 17a and the third fuel injection orifices 17b based on the penetration depth of the same into the combustion chamber of the respective cylinder. Accordingly, the second fuel injection orifices 17a in FIG. 3 are arranged deeper in the combustion chamber than the third fuel injection orifices 17b. In FIG. 4, by contrast, the third fuel injection orifices 17b arranged deeper or further in the combustion chamber than the second fuel injection orifices 17a.

While in FIG. 3 the nozzle needle 15 is flowed about by the second fuel and also flowed through by the second fuel, the nozzle needle 15 in FIG. 4 is exclusively flowed about by the second fuel.

As already explained above, the third fuel injection orifices 17b have a larger flow cross-section than the second fuel injection orifices 17a. The number of the third fuel injection orifices 17b can also be greater than the number of the second fuel injection orifices 17a. The number of the second fuel injection orifices 17a however can also correspond to the number of the third fuel injection orifices 17b. Preferentially, at least some, particularly preferably all, second and third fuel injection orifices are arranged offset relative to one another in the circumferential direction, namely on concentric circular paths.

With the invention, a combustion chamber of a cylinder of an internal combustion engine can be optimally filled with fuel, namely in particular both when first relatively less ignitable fuel is to be combusted via ignition with the help of a second, relatively ignitable fuel, but also in particular when exclusively the second, relatively ignitable fuel is to be combusted. Thus, the efficiency can be increased. Further, NOx emissions can be lowered.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A fuel injector of an internal combustion engine, configured to supply fuel to a combustion chamber of a cylinder of the internal combustion engine, comprising:
a first needle guide;
first fuel injection orifices;
a first nozzle needle that is moveably guided in the first needle guide, and interacts with the first fuel injection orifices such that the first nozzle needle, depending on its position, either opens or blocks a fuel flow of a first, relatively less ignitable fuel through the first fuel injection orifices;
a second needle guide;
second fuel injection orifices;
third fuel injection orifices;
a second nozzle needle that is moveably guided in the second needle guide, which interacts with the second fuel injection orifices and the third fuel injection orifices such that the second nozzle needle, depending on its position, either:
blocks a fuel flow of a second, relatively ignitable fuel both through the second fuel injection orifices and also through the third fuel injection orifices,
opens the fuel flow of a second, relatively ignitable fuel through the second fuel injection orifices and blocks the fuel flow of a second, relatively ignitable fuel through the third fuel injection orifices, or
opens the fuel flow of a second, relatively ignitable fuel both through the second fuel injection orifices and also through the third fuel injection orifices,
wherein the first fuel injection orifices are configured to inject the first fuel in a first spray cone with a first cone angle into a combustion space,
wherein the second fuel injection orifices are configured to inject the second fuel in a second spray cone with a second cone angle into the combustion space, and
wherein the third fuel injection orifices are configured to inject the second fuel in a third spray cone with a third cone angle into the combustion space.

2. The fuel injector according to claim 1,
wherein the second cone angle is smaller than the third cone angle.

3. The fuel injector according to claim 1,
wherein the first cone angle is smaller than the second cone angle.

4. The fuel injector according to claim 1,
wherein the first cone angle is greater than the second cone angle and smaller than the third cone angle.

5. The fuel injector according to claim 1,
wherein the first fuel injection orifices are arranged along a pitch circle contour,
wherein the second fuel injection orifices are arranged along a first circular contour,
wherein the first fuel injection orifices arranged along a second circular contour,
wherein the first circular contour and the second circular contour are arranged concentrically to one another,
wherein a distance between a centre point of the pitch circle contour and a centre point of the first and second circular contour is greater than a sum of a radius of the pitch circle contour and of the radius of the first circular contour and greater than a sum of the radius of the pitch circle contour and of a radius of the second circular contour.

6. The fuel injector according to claim 5,
wherein in an installed state of the fuel injector, the second and/or third fuel injection orifices project deeper or further into the combustion chamber of the cylinder than the first fuel injection orifices.

7. The fuel injector according to claim 5,
wherein the second fuel injection orifices and the third fuel injection orifices, seen in circumferential direction, are at least partially offset relative to one another.

8. The fuel injector according to claim 5,
wherein the first and second circular contour, on which the second and third fuel injection orifices are arranged, each cover an angular range of 360°.

9. The fuel injector according to claim 5,
wherein the pitch circle contour, on which the first fuel injection orifices are arranged, covers an angular range of 360°-δ, wherein a residual pitch circle contour defined by δ, on which no first fuel injection orifices are arranged, faces the first and second and second circular contour.

10. An internal combustion engine, comprising:
cylinders which are equipped to ignite with help of a second fuel, a first fuel for combusting the first fuel in the cylinders,
wherein each cylinder comprises a fuel injector, comprising:
a first needle guide;
first fuel injection orifices;
a first nozzle needle that is moveably guided in the first needle guide, and interacts with the first fuel injection orifices such that the first nozzle needle, depending on its position, either opens or blocks a fuel flow of a first, relatively less ignitable fuel through the first fuel injection orifices;
a second needle guide;
second fuel injection orifices;
third fuel injection orifices;
a second nozzle needle that is moveably guided in the second needle guide, which interacts with the second fuel injection orifices and the third fuel injection orifices such that the second nozzle needle, depending on its position, either:
blocks a fuel flow of a second, relatively ignitable fuel both through the second fuel injection orifices and also through the third fuel injection orifices,
opens the fuel flow of a second, relatively ignitable fuel through the second fuel injection orifices and blocks the fuel flow of a second, relatively ignitable fuel through the third fuel injection orifices, or
opens the fuel flow of a second, relatively ignitable fuel both through the second fuel injection orifices and also through the third fuel injection orifices,
wherein the first fuel injection orifices are configured to inject the first fuel in a first spray cone with a first cone angle into a combustion space,
wherein the second fuel injection orifices are configured to inject the second fuel in a second spray cone with a second cone angle into the combustion space, and
wherein the third fuel injection orifices are configured to inject the second fuel in a third spray cone with a third cone angle into the combustion space.
